(19) United States
(12) Patent Application Publication
(10) Pub. No.: US 2009/0243791 A1
(43) Pub. Date: Oct. 1, 2009

(54) Mini fob with improved human machine interface

(76) Inventors: Dale L. Partin, Ray Township, MI (US); Michel F. Sultan, Troy, MI (US); Carsten Hildebrand, Wuppertal (DE)

Correspondence Address: DELPHI TECHNOLOGIES, INC., M/C 480-410-202, PO BOX 5052, TROY, MI, 48007, US

(21) Appl. No.: 12/079,713

(22) Filed: Mar. 28, 2008

(51) Int. Cl. H04L 17/02; H04B 1/00

(52) U.S. Cl. 340/5.2; 341/176

(57) ABSTRACT

A remote control device for a vehicle remote access system includes the housing, an input switch for selecting a vehicle control function, a control, a transmitter for transmitting a wireless signal from the control to the vehicle remote access system, and an attachment for mounting the housing on or integrating it with a separate article carried or worn by a user. The input switch can be a single pressible member, the number of time spaced sequential activations and the duration of each activation of which is determined by the control member to indicate a selected one of a plurality of distinctive vehicle control functions. The input switch member can alternately be a slidable or a rotary multi-position switch in which each position designates a distinct vehicle control function. A rechargeable battery can be carried in the housing and receives recharging electric power from a plug on the housing which is connectable to an external power supply, a solar cell carried on the housing, or an inductive secondary transformer coil carried in the housing.

### BACKGROUND

The present invention relates, in general, to remote access systems and, in particular, to fobs used with remote access systems.

Remote keyless entry (RKE) fobs are used by a significant number of vehicle owners to remotely control selected vehicle functions, such as unlocking or locking vehicle doors, unlocking the rear hatch or trunk, remotely starting the vehicle, activating the vehicle horn and lights, opening and closing sliding doors or a rear lift gate.

Remote keyless access systems require a fob which is a discrete component, typically attached to the vehicle key ring or integrated in an enlarged housing mounted on the end of the vehicle key. As such, fobs are typically kept in a person's pocket or purse and must be retrieved for use. This takes time and can be difficult if the person is carrying a child, groceries, etc., particularly in inclement weather.

The fobs also take up space and are one more thing for a person to carry along with other nomadic, mobile devices, such as a cell phone, a PDA, etc.

One way to reduce the number of separate articles carried in a person's pocket or purse is to integrate an RKE fob with a cell phone where software in the cell phone is used to enable the cell phone to communicate with the vehicle remote keyless entry system through the cell phone towers and cell phone carrier. Typically, such an integrated device would require a user to remove the cell phone from its holster, or from the user's pocket, open the phone if it is a flip phone, and then input one or more commands, such as by pressing buttons or keys on the cell phone keyboard that would place a call to the vehicle RKE system instructing the RKE system to perform the desired functions. This process, however, is more difficult than simply removing a fob from one's pocket or purse and pressing one button to send a command to the vehicle RKE system 18.

It would be desirable to provide the remote keyless entry (RKE) fob as an integrated device exteriorly on an article carried or worn by a person to allow easy one-hand access to the fob inputs and/or outputs to simplify the human machine interface between the user and the fob.

It would also be desirable to provide a remote keyless entry (RKE) fob that is small in size so as to be able to be attached to or integrated with an article carried or worn by a person wherein the RKE fob is optionally able to serve as a back-up or auxiliary fob for a vehicle. The small fob size enhances the human machine interface between the user and fob since its small size means that it does not take up much space or add appreciable bulk to articles that a person normally carries or wears.

### SUMMARY

A vehicle function control apparatus includes a remote access receiver mountable on a vehicle and generating signals to operate vehicle control functions, and a remote communication apparatus including a housing, a single or multifunction input means or switch on the housing for selecting at least one vehicle control function, a control carried in the housing, and generating a signal associated with a vehicle control function selected by the input switch, a transmitter carried in the housing and connected to the control for transmitting a signal to the remote access apparatus on the vehicle, and an attachment mounting the housing on a separate article which carried or worn by the user.

The attachment can be one of a clip, a snap, a band with joinable ends, a magnetic connector sewn components, etc. The attachment can also be done by integrating the fob with the article that it is attached to. The attachment can mount the housing on at least one of a cellular telephone holder case, holder or holster, a purse, a briefcase, a watchband, a cellular telephone battery cover, a belt, a badge worn by a user, a piece of jewelry worn by a user, a vehicle key, or a key case. The attachment can include the fob housing already attached to an article that is to be worn or carried, or it can include the fob housing with an attachment means suitable for the user to attach the fob to a desired article that is worn or carried.

The small size of the fob facilitates its attachment or mounting to an article in a manner that at least partially or entirely conceals the fob from view.

A battery power source is carried in the housing and provides electric power to the control and the transmitter. The battery power source can be a rechargeable battery. The rechargeable battery can include a plug connection for supplying recharging power to the battery from a power source externally of the housing, a secondary transformer inductive coil carried in the housing for supplying current to the battery in response to proximate association with an external current carrying transformer primary coil, or a solar cell carried on the housing and connected to the battery for supplying recharging power to the battery.

The apparatus can also include an optical function indicator, carried on the housing, for indicating a vehicle function selected by the input switch.

The apparatus can also include a battery power level detector carried in the housing and generating the signal indicative of a low battery power level and an indicator carried on the housing indicate a low battery power level.

The apparatus, when configured for bi-directional communication, can also include a visual indicator, carried on the housing, for indicating that a selected vehicle control function transmitted by the transmitter to the vehicle remote access receiver has been received by the vehicle remote access receiver.

The apparatus can include an RFID circuit carried by the housing and generating an RFID signal. The power to operate the RFID circuit may come from a battery inside the housing, or from an antenna on the vehicle, when the housing is close to the vehicle, or alternatively, the power may come from the article the RFID circuit is attached to, for example, if an RFID circuit is attached to the inside or outside of a cellular telephone, the cellular telephone battery may be used to power the RFID device.

The input switch can be a pressible member, a slidable multi-position member, or a rotary multi-position member. The input switch can also be a slidable or rotary member and have multiple positions, each associated with a distinct vehicle control function and a selector member or input switch, carried on the housing, for inputting a signal from the input member corresponding to the position of and the control function associated with the input switch member to the control. The input switch can be a pressible member, in which different functions can be determined by the number and duration of closely spaced presses or inputs.

The apparatus can also include a second input switch carried on the housing, and coupled to the control to generate a signal to the control, in response to which the control changes the vehicle control functions associated with a first input switch member.

The control can be responsive to at least one of the number of sequential activations and the duration of each activation of the input switch members to select one of the vehicle control functions.

In one aspect of the apparatus, the housing is a separable battery cover of a cellular telephone, the attachment mounting the input switch, the control, and the transmitter on an exterior surface of the battery cover. Connections may also be carried by the battery cover and coupled to the control for supplying electric power from a cellular telephone battery carried by the battery cover to the control.

In one aspect, the housing has a thin, credit card shape, with the input switch, the control, and the transmitter mounted on the card. The card may be a credit or debit card.

### BRIEF DESCRIPTION OF THE DRAWING

The various features, advantages and other uses of a fob with improved human machine interface will become more apparent by referring to the following detailed description and drawing in which:

FIG. 1A is a plan view of one aspect of a remote keyless entry (RKE) fob;

FIG. 1B is a side elevational view of one aspect of the fob shown in FIG. 1A;

FIG. 1C is a side elevational view of another aspect of the fob shown in FIG. 1A;

FIG. 2 is a plan view of another aspect of an RKE fob;

FIG. 3 is a plan view of another aspect of an RKE fob;

FIG. 4 is a plan view of another aspect of an RKE fob;

FIG. 5 is a plan view of another aspect of an RKE fob;

FIG. 6 is a plan view of another aspect of an RKE fob;

FIG. 7 is a plan view of another aspect of an RKE fob;

FIG. 8 is a perspective view showing the mounting of a fob depicted in FIG. 1A in a ring;

FIG. 9 is a perspective view showing the mounting of a fob on a wristwatch band;

FIG. 10 is a cross sectional view generally taken along line 10-10 in FIG. 9;

FIG. 11A is a plan view of another aspect of a fob integrated with a mobile cellular telephone holster;

FIG. 11B is a side elevational view of the fob and holster shown in FIG. 11A;

FIG. 12A is a plan elevational view of another aspect of a fob integrated with a key case;

FIG. 12B is a side elevational view of the fob and key case shown in FIG. 12A;

FIG. 13 is a plan view of another aspect of a fob mounted in a cellular telephone battery cover;

FIG. 14 is a block circuit diagram showing an exemplary circuit employed in an RKE fob; and

FIG. 15 is a front view of an RKE fob integrated with a credit card sized plastic member;

FIG. 16 is a perspective view of a vehicle incorporating a vehicle remote access control apparatus;

FIG. 17 is an elevational view of a fob mounted on the rear surface of a pin or broach; and

FIG. 18 is a schematic diagram of an RFID integrated with a fob.

### DETAILED DESCRIPTION

Referring now to the drawing, various aspects of a remote keyless entry (RKE) fob, hereafter referred to generally as a “fob”, will be initially described. Then, the mounting of the various aspects of the fob in various articles worn or carried by a user will be presented.

It will be understood that the various aspects of the fob can generally be used with any fob mounting arrangement and/or any fob power source, including various rechargeable power sources, and with unidirectional or bidirectional fob communication modes.

Referring briefly to FIG. 16, an exemplary base station 18 is mounted in a vehicle 19. The base station 18 is referred to as a remote keyless entry base station or RKE 18 which includes a receiver for receiving wireless electronic signals from a transmitter carried in a fob 20 upon activation of an input switch member, such as a pushbutton 24 mounted in a fob housing 22. The wireless signal transmitter transmits signals which can be a radio frequency (RF) signal to the RKE 18 when the user carrying the fob 20 is in range or a predetermined distance with respect to the RKE 18. The receiver of the RKE 18 is directly or indirectly electrically coupled to one or more systems or devices in the vehicle 19 that execute vehicle control functions. A processor or controller is coupled to the receiver to decode the wireless control signal from the fob 20 so that the requested vehicle control function can be determined and executed. For example, the RKE controller may be coupled to vehicle door and/or rear hatch or trunk locking mechanisms, a vehicle alarm system, interior or exterior vehicle lights and vehicle horn, a vehicle alarm system, an ignition start system, and window closure mechanisms. The electrical connection between the RKE controller and the vehicle function mechanisms may be implemented through a vehicle body or engine controller to which each of the control function mechanisms are coupled.

The receiver in the RKE 18 as well as the transmitter in the fob 20 may be provided for bidirectional transmission as transceivers or transponders. In such an arrangement, the fob 20 may include a visual display, such as indicator lights, a buzzer or beeper, or an LCD graphical display panel, to convey information to the user relating to vehicle function status, such as engine running, door lock status, intrusion alarm activation, interior temperature, etc.

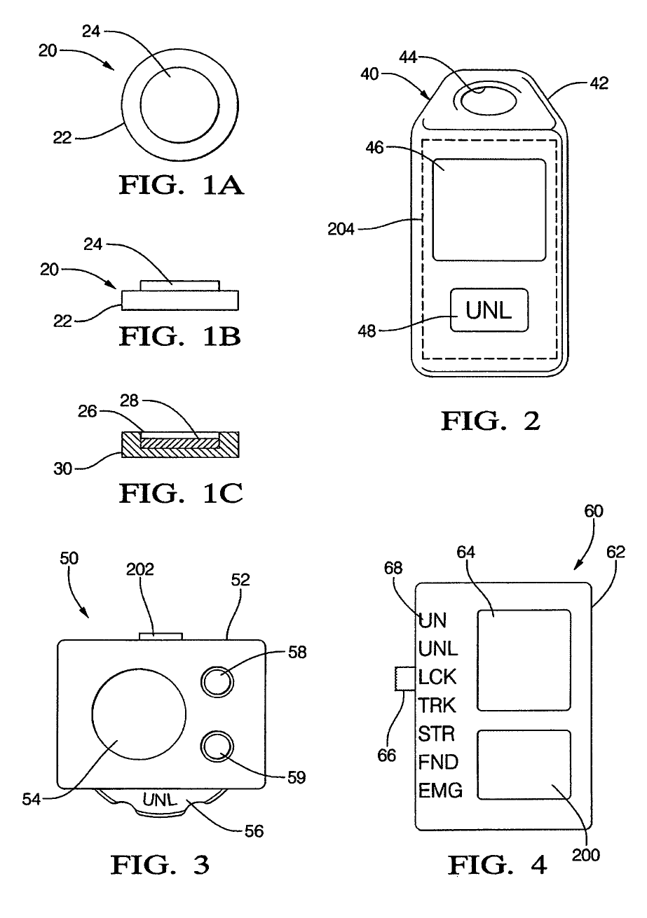

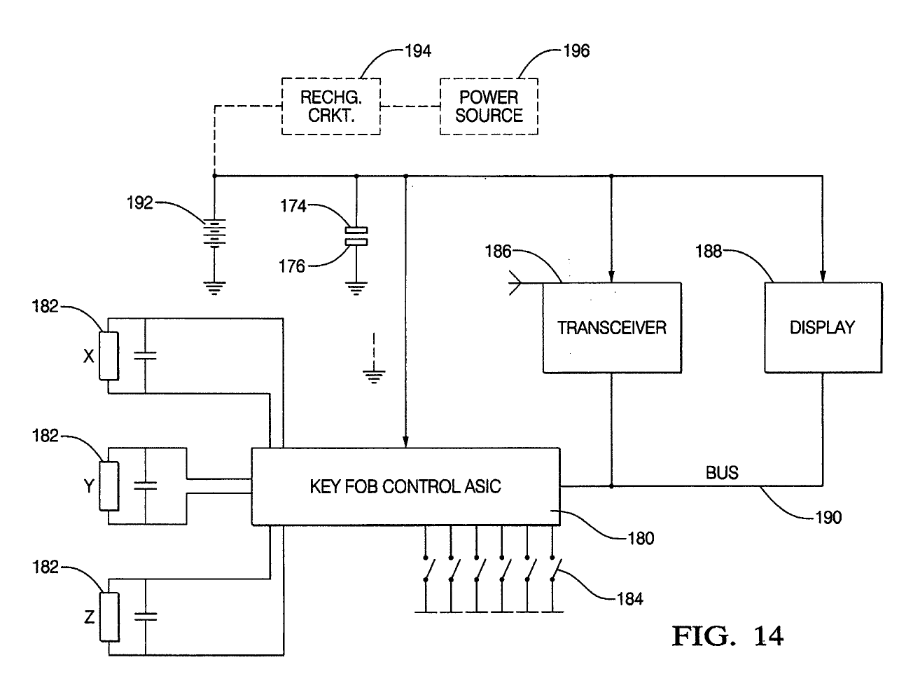

As shown in FIGS. 1A, 1B, and 1C, one aspect of a fob 20 is depicted which includes a housing 22 containing the fob control circuit, and power supply, as generally shown in FIG. 14, and an input switch member 24, which, in this aspect, is a single depressible or touch responsive pushbutton 24.

The pushbutton 24 may be any suitable pushbutton which generates an electrical signal through a contact, switch, etc., to the fob circuit when it is touched, depressed or otherwise activated. As shown in FIG. 1B, the pushbutton 24 may be at least partially raised or extending beyond the outer surface of the housing 22. Alternately, as shown in FIG. 1C, a pushbutton 26 may be mounted in a recess 28 in a fob housing 30 to minimize the potential for inadvertent activation of the pushbutton or input switch member 26.

The input switch member or pushbutton 24, 26 may take any shape, such as the depicted circular shape, as well as polygonal, including square, triangular, rectangular, and or arcuate curved shapes.

Another aspect of a fob 40 as shown in FIG. 2, in which a fob housing 42 containing the fob control circuit has an optional tab 44 to facilitate connecting the fob housing 42 to another object. One of more tabs 44 may be used, for example, to facilitate sewing the fob to an article of clothing. Or a single large tab 44 with multiple openings may be used. The fob 40 may also be attached to a purse, briefcase or sleeve outside the opening or just inside to balance concealment with convenient access. The exterior of items such as a purse or article of clothing is thus generalized to include portions of such items that are very quickly and easily accessible, or “nearly” exterior. The fob 40 has a single input switch member 46 as well as an output element 48, such as an optical display or other visual indicator which displays the vehicle control function selected by the user through the fob input switch member 46.

In the fobs 20 and 40 shown in FIGS. 1A, 1B, 1C, and 2, the single input switch member or pushbutton 24 and 46 may be activated or pressed to input switch various coded commands to the fobs 20 and 40 via the number and/or duration of the closely spaced input switch member depressions or activations. For example only, a single short input, such as a single short depression or touch of the input switch member or pushbutton 24 and 46 could cause the control circuit of the fob 20 or 40 to generate and transmit a signal to the vehicle RKE system 18 to unlock the vehicle driver door. Two quick inputs from the input switch member 24 or 46 could cause a signal to be generated by the fob 20 or 40 to lock either the driver's door or all vehicle doors. In either case, a longer, such as a one second, depressing or touching of the input switch member 24 or 46 could cause the fob 20 or 40 to briefly activate the vehicle horn and lights to signal an emergency or to facilitate location of the vehicle. A three-second input from the input switch members 24 or 46 could activate the vehicle horn and/or lights for a longer interval, such as thirty seconds, to denote an emergency, and a subsequent three-second input would create a “cancel emergency” function signal. For these implementations in which a single input switch can activate more than one vehicle function, the input switch may be referred to as a multifunction input switch.

The colors used in the housing 22 and pushbutton 24 may be decorative, complementary to each other, or otherwise provided in various hues to coordinate or contrast with the articles on which they are to be mounted.

The fob 20 or 40 may be made waterproof or water resistant. This would enable the fob 20 or 40 to be ordinarily worn by a user when washing their hands, taking a shower, etc. Also, if the person goes to the beach or swimming, the vehicle keys must be protected against theft. It would be convenient to leave the vehicle keys locked in a vehicle. A waterproof fob 20 or 40 mounted on a ring, wristband, wristwatch band, necklace or otherwise clipped or attached to the person's swimsuit would enable the person unlock their vehicle while safely protecting the vehicle keys from theft.

In addition to depressing or a touch activation of the input switch member 24 or 46, other types of mechanical inputs can be used in the fob 20 or 40, such as squeezing the outer portion of the housing 22 or 42 adjacent to an input switch member or flexing the entire housing 22 or 42. In either fob 20 or 40, inputting quick push button presses or activation of the fob input switch member 22 or 46 would cycle the fob control circuit through various modes, such as UN (unlock driver door only), UNL (unlock all doors), LCK (lock all doors), TRK or HCH (unlock trunk or hatch), STR (start vehicle remotely), FND (activate horns and/or lights briefly to help locate vehicle), EMG (activate horn and/or lights for a longer period to indicate an emergency), etc.

Another feature that can be included in either fob 20 or 40 is that when the input switch member or push button 46 is depressed continuously at any time for at least three seconds, an emergency situation is assumed and the vehicle horn and lights will be activated for an extended period of time.

In the fob 40, a bidirectional RKE communication circuit is provided between the vehicle RKE system 18 and the fob 40. The fob 40 may also display the selected vehicle control function in the indicator 48 for a predetermined period of time, such as one to five minutes, for example. This would assist the user in remembering whether or not they locked their vehicle. The display or indictor 48 could also be activated on a low power duty cycle, such as for one second every five seconds, to reduce power consumption.

An optional feature for the fob 20 or 40 is that the fob control circuit can reset to a default condition in the cycle of functions, which would be UN, for example only, as the first function, after the predetermined display time. In this manner, the user knows that each time spaced use of the fob will have the function sequence starting at the same default function.

The indicator 40 may also provide a LOW signal to indicate a low battery condition. Alternately, the fob 40 may be configured such that a single, brief depression of the input switch member or button 46 causes the fob control circuit to cycle through all of the vehicle control functions sequentially, displaying each one for a short period of time, such as for about one second, for example, in the optical indicator 48. Where the desired function is displayed on the indicator 48, the input switch member 46 is again depressed, causing the selected vehicle control function to be activated.

Referring now to FIG. 3, there is depicted a fob 50 having a housing 52. In this aspect, the fob 50 also includes an activatable or depressible input switch member 54, such as a pushbutton similar to the pushbutton 24 or 46.

The fob 50 has a second function selector input switch member 56 in the form of a rotary or thumbwheel switch having multiple positions which are rotatably selected for one of a plurality of vehicle functions. The various vehicle control functions UN, UNL, etc., can be printed on separate positions of the thumbwheel switch 56. Since at least a portion of the thumbwheel switch 56 projects outward from the side of the housing 52, at least one vehicle function is displayed at a time. The thumbwheel 56 may be provided with a mechanical detent in the housing 52 so as to provide separate, easily distinguishable positions of the thumbwheel 56. The detent may provide an audible click to indicate that the thumbwheel 56 has been moved to a new position while being rotated. The rotary switch 56 may be referred to as a multifunction input switch.

In operation, the user rotates the thumbwheel 56 until the desired vehicle control function is displayed, such as the UNL function depicted in FIG. 3. The user then briefly depresses the input switch member 54 which causes the fob 50 to generate the selected vehicle control function. Optionally, a longer, such as a three second, button press will always indicate an emergency function causing the vehicle horn and/or lights to be activated for an extended period of time.

The user can merely look at the thumbwheel 56 to see which vehicle control function will be activated if the input switch member or button 54 is pressed and, also, can see the last function that was activated assuming that the thumbwheel 56 position has not changed since the last activation.

Fluorescent material can be used on the vehicle function characters, UN, UNL, etc., or for the background of the thumbwheel 56 surrounding each character so that the switch position is visible in the dark or low light intensity conditions. The switch positions can also be provided in different colors to facilitate rapid identification.

The fob 50 also depicts an optional output to indicate that the vehicle control function signal generated by depression of the input switch member 54 was or was not received by the vehicle RKE system 18. This requires bidirectional fob capability as shown in FIG. 14. The output members may be two LED's 58 and 59 mounted on the housing 52. One of the LED's 58 may emit a green light to indicate that the vehicle RKE system received the selected vehicle control signal from the fob 50. A red LED may be used for the output member 59 to indicate that a signal was not received within a predetermined time after depression of the input switch member 54.

Alternately, a single LED may be used as the output member and briefly illuminated after the button 54 is pressed to indicate that the vehicle RKE system 18 received the signal. A non-illumination of the single output member will indicate a non-reception of the fob generated signal.

Alternately, the fob 50 may provide an output indication that the vehicle RKE system 18 received the selected vehicle control signal or command by providing an audible signal, such as one or two beeps or a haptic output in the form of vibrations of the housing 50.

A low battery condition can be indicated by an occasional periodic flash from the output member, particularly the red output member 59, or by a periodic audible beep or haptic vibration.

A fob 60 is shown in FIG. 4 which includes a housing 62, an activatable input switch member 64 and a function selector member 66. In this aspect, the vehicle function selector member 66 is in the form of a slide switch having multiple discrete selectable positions, each with a vehicle function indicator UN, UNL, etc., disposed on the exterior side edge of the housing 62. The exterior slide member 68 of the slide switch 66 extends outward from the side edge of the housing 62 to enable easy movement of the slide member 68 between selected positions. When the desired vehicle control function is selected, such as LCK, a single brief depression of the input switch member or button 64 causes the fob 60 to generate and transmit the selected vehicle control function to the vehicle RKE 18. As in previous aspects, a longer duration depression of the input switch member 64 will cause the fob 60 to generate and transmit a signal to the vehicle RKE system 18 indicating involvement in an emergency condition. The slide switch 66 may be referred to as a multifunction input switch 66.

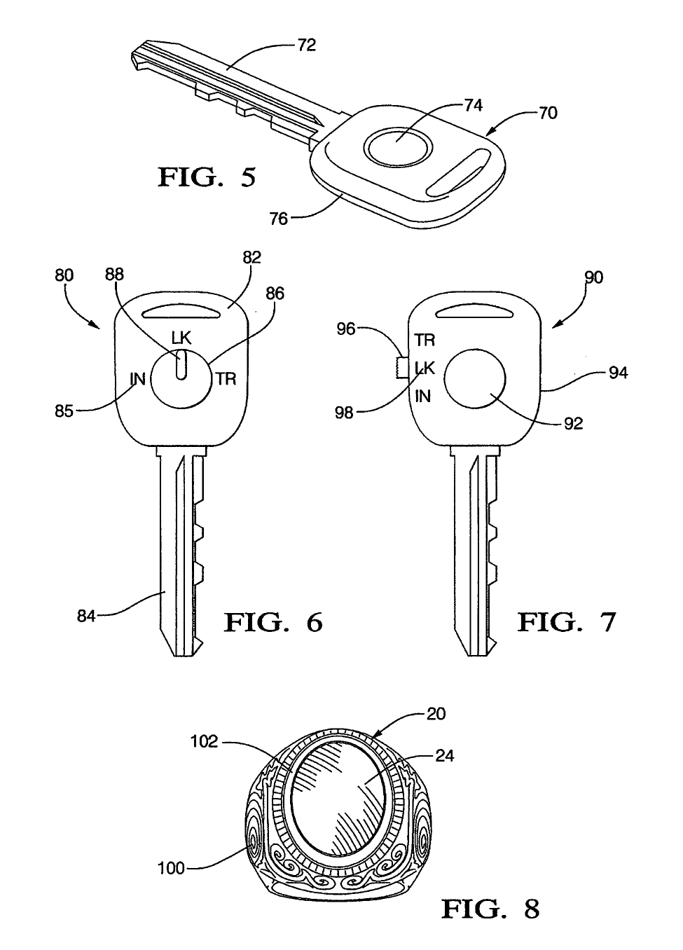

Referring now to FIG. 5, there is depicted the integration of a fob 70 with a vehicle key 72. The key 72 may be described as the key blade 72. Here, the fob is integrated with the key blade 72 and replaces a handle for the key 72. The fob 70 includes a single pressible input switch member 74, such as the input switch members 24 and 46 described above and shown in FIGS. 1A and 2. The position of the pressible input switch member 74 on the fob housing 76 may be different from that shown in FIG. 5.

The integration of the fob 70 with the key 72 results in a much smaller fob housing than present day fobs mounted on the end of a vehicle key blade which greatly facilitates storage of the integrated fob 70 and key 72 in a key case, or in an immediately available receptacle or pouch on one's belt, mobile phone holster, etc. In one aspect, the length of the fob housing 76 that is integrated with the key blade 72 is at least 20% shorter than the key blade 72 in the long direction of the key blade 72, and may be at least 30% shorter, to facilitate storage of the key blade 72 in a key case, pouch integrated fob 70, etc. These preferences apply also to the aspects of the fobs depicted in FIGS. 6 and 7. The other dimensions of the fob 70 are comparable to or shorter than the length of the fob 70 in the direction of the key blade 72. Typically, one of the other dimensions, such as the thickness, is much shorter than the length of the fob 70 in the direction of the key blade 72, as shown in FIGS. 5, 6 and 7.

More than one button or input switch member 74 may be provided on the fob housing 76 for added vehicle control functionality. A key case or other receptacle could also be supplied with the key 72 to facilitate attaching and keeping the key in a conveniently accessible location, such as on the user's purse or briefcase, cell phone holster, etc.

Referring now to FIG. 6, there is depicted a fob 70 which combines the rotary thumbwheel switch 56 shown in FIG. 3 with the single input switch member feature of the fob 70 mounted on the end of a vehicle key or blade 72 shown in FIG. 5.

The fob 80 includes a housing 82 mounted on one end of a vehicle key 84 and integrated with the key blade. An input switch member 86 is carried on the housing 82 and is provided with both a rotary and a depressible signal generating capability. The input switch member 86 may be rotated between a discrete vehicle control function signal generating positions, such as UN, LK, TR, printed or otherwise visible on the exterior surface of the housing 82 by aligning a pointer 88 formed or printed on the exterior surface of the input switch member 86 with one of the discrete vehicle function indicia 85. The pointer 88 may be raised or elevated from the main surface of the input switch member 86 to facilitate rotation of the input switch member 86. Alternatively, a separate, pressible switch which is separately located on the fob housing 82 may be provided to activate the function selected with the rotary switch 86.

In use, the input switch member 86 is rotated to align the pointer 88 with a selected one of the vehicle control functions indicia 85. Then, the user depresses the input switch member 86 briefly to cause the fob 80 to generate and transmit the selected vehicle function indicated by the pointer 88 to the vehicle RKE system 18.

In a fob 90 mounted, for example, on one end of a key as shown in FIG. 7, a first input switch member 92 is mounted is carried on a housing 94. The input switch member 92 may be a single pressible pushbutton 24 shown in FIG. 1A or the single pushbutton 64 shown in fob 60 and depicted in FIG. 4.

A slidable vehicle control function switch or input switch member 96 extends from one side of the housing 94 and is movable between discrete vehicle control function indicating positions, such as TR, LK, and UN. As with the fob 80 shown in FIG. 6, the user moves the actuator 96 to the desired vehicle control function position 98 and then briefly depresses the input switch member 92 which causes the fob 90 to generate and transmit the selected vehicle control portion of the vehicle RKE 18.

Various aspects of the fobs 20, 40, 50, 60, 80 and 90 described above, can be attached or integrated into an article which is worn or carried by a user, such as a vehicle driver. The fobs 20, etc., can be mounted on the exterior surface of such articles by using an adhesive, magnet, clip, snap, sewing, Velcro™, to etc., to facilitate easy use without having to reach into a pocket or purse, etc. and withdraw the fob before the fob functions can be selected. A fob attached to a purse, bag, briefcase, etc., may be in the form of a decorative item, such as, for example, a flower in which various parts of the flower are the input switch members and define different fob functions or serve to removably contain one or more vehicle keys. In some aspects, there are two levels of integration or attachment possible. For example, a fob permanently integrated with a vehicle key is one such level, and such an integrated fob/key that is then temporarily or removably attached to a belt, cellular telephone holster, etc. is a second level.

For example, any of the fobs described above or hereafter can be integrated with articles that are commonly worn on or carried by a person, such as a mobile phone holster, mobile phone housing, purse, belt, wristwatch strap, employee badge, jewelry (such as a brooch, bracelet, necklace, ring, hairclip, earring), clothing, shoes, pen or pencil, eyeglass frame, key case, cell phone headgear or ear bud, handbag, briefcase, etc.

In some aspects, concealment of the fob by means of an openable or removable cover may be provided for security purposes. Concealment may also be effected by camouflage, by attaching or integrating with a ring or other article mentioned above so that the fob functionality is not obvious to others, or by attaching a small fob just inside a sleeve, lapel, handbag, etc. This facilitates improving the person's appearance, and also is a security feature, so that the fob is not stolen. Concealment is facilitated by making the fob small. This is an improvement over having a conventional fob normally concealed in one's pocket or handbag. Thus, concealment may be achieved without sacrificing convenience, thus improving the human machine interface.

As shown in FIG. 8, the single input switch member fob 20 is depicted as being mounted on a piece of jewelry, such as a finger ring 100. The housing 22 can be mounted within the interior of the raised portion 102 of the ring 100 with only the exterior portion of the input switch member or pressible button 24 exposed.

The ring 100 and housing 22 could be at least water resistant or water proof and would serve a “never lock yourself out of the car” function. The fob 20 may optionally have a reduced communication range, such as one or two meters from the vehicle, in order to conserve battery charge. The fob 20 could be programmed via a small input plug on the back of the ring, for example, or by removing the back of the ring 100 to gain access to the interior mounted electronics of the fob 20. The input plug could also be used to recharge the fob battery, as described hereafter. Alternatively, the access to the back of the ring 100 could be used to change a non-rechargeable battery.

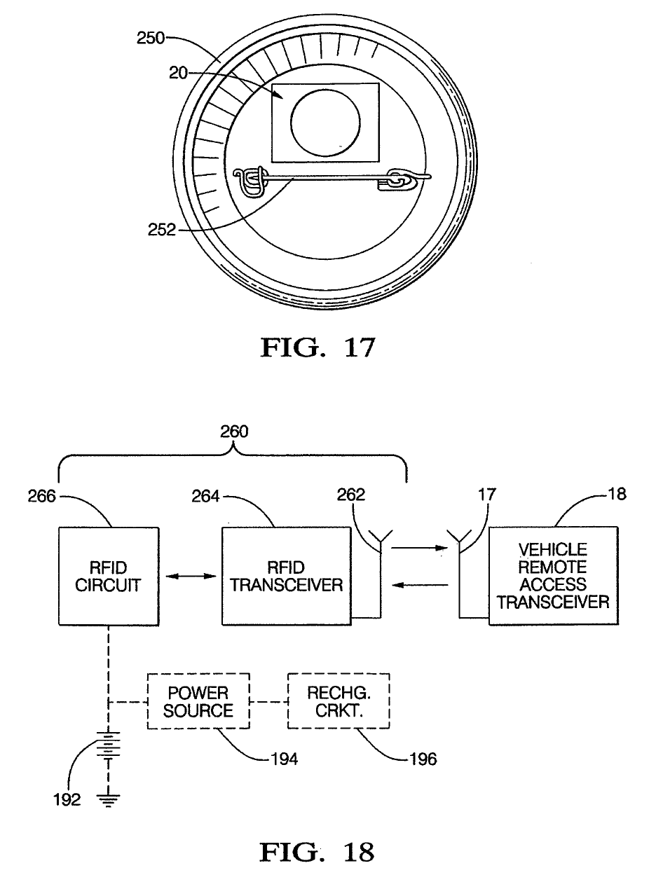

The small size of the fob, such as fob 20, enables it to be partially or entirely concealed from view when attached to an article. One example is shown in FIG. 17. Here the fob 20 is attached to the back of a pin or broach 250. Concealment may be accomplished in two ways. First, the broach 250 may be worn in plain view attached somewhere to one's clothing, purse, etc. by a pin or clip 252. Typically, it would be worn on the front of a blouse, sweater, etc. Concealment is accomplished by the fact that it is not obvious that there is a fob 20, or RFID device, on the back of the broach 250. The fob 20 could be sold or supplied already attached to the broach 250. The fob 20 could also be sold by itself, with a means to attach it to whatever the person wants to attach it to. This could, for example, be done by providing an adhesive on one side of the fob 20 with a peel-off cover. When the cover is peeled off, the person can attach the fob 20 to whatever article he/she wants to. Alternatively, the broach 250 could be pinned on the back side of an article of clothing, such as a sweater or coat near the neckline. Thus, it would not be visible to others, but could easily be reached for use.

Another way to conceal the fob 20 would be to make the housing of the fob 20 itself visible, when attached or worn on an article, but appear to be something else, such as an earring or tie tac. The fob 20 would have an attractive shape, color, etc., and have an attachment for such articles.

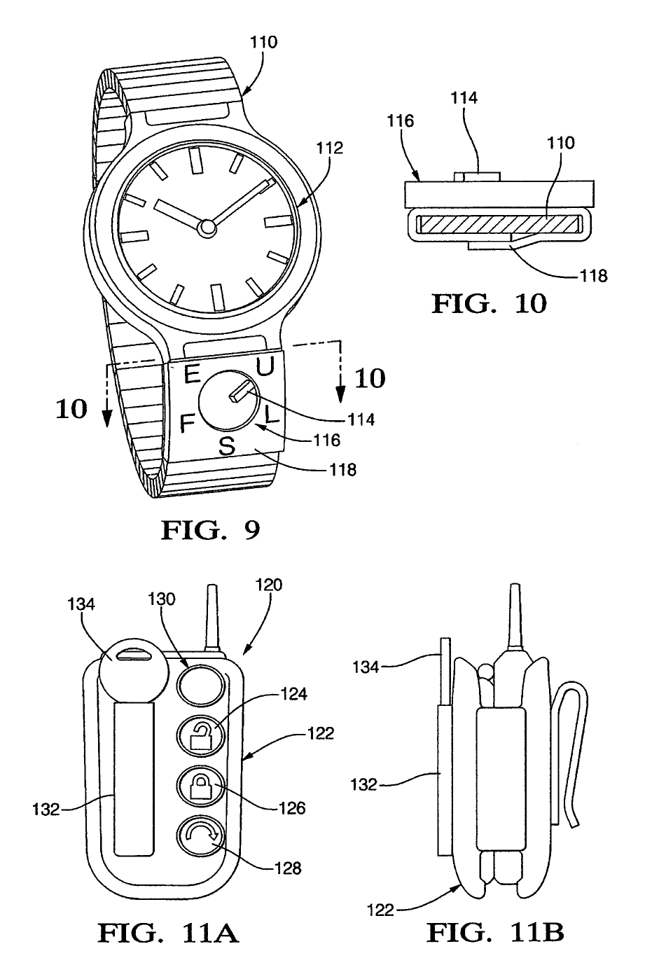

The rotary, multiple position input switch member 86 on the fob 80, with additional vehicle function positions can be mounted on the band 110 of a wristwatch 112 as shown in FIGS. 9 and 10. The rotary input switch member 114 of the fob 116 is mounted in a band strap, clip, snap, or fixedly mounted on the wristwatch band 110 by suitable means, including a magnetic attachment, a clip, snap, Velcro™, etc., as shown in FIG. 10. The band 118 has free ends which wrap around a portion of the wristwatch band 110 and are secured together by any of the above-described fasteners or coupling means 30. Alternatively, the fob 116 could replace a portion of the band 110 and be attached to it at two sides of the fob 116 or be attached to the band 110 at one side and to the wristwatch 112 at the other side. Other aspects of fobs with either a pressible, squeezable, flexural or slidable switch (whether multifunctional or single functional) as previously described can also be mounted on a wristwatch band.

As shown in FIGS. 11A and 11B, a fob 120 is integrated with or carried on a mobile phone holster or carrying case 122 by attachment to or as an integral part of the holster 122. The fob 120 includes at least one and, as shown by way of example only in FIG. 11A, a plurality of input switch buttons arranged in a first set of input switch buttons 124, 126, and 128, each having a different pre-assigned vehicle function as shown by the indicia or characters visible on each input switch member. The input switch members 124, 126, and 128 may be pressible pushbuttons, touch switches, or combined into a slide switch similar to the slide switch 96 or the rotary multi-position input switch member 86. The input switch members 124, 126 and 128 can be made to be easy to locate by touch and to use since they may be larger than normal fob buttons.

By way of example only, the input switch members 124, 126, 128 activate fob and vehicle functions associated with unlocking the vehicle driver's door, locking all of the vehicle doors, starting the engine, respectively.

A second input switch member 130, which may also include one or more input switch members, is also integrated with the case or holster 122. The second input switch member 130 which may be a pressible button, touch switch, a rotary switch, etc., is provided in a different color to indicate a different vehicle control function. By way of example only, in this aspect, pressing the second input switch member 130 once for a short duration of time will cause the fob control circuit to switch the functions of the input switch members 124, 126 and 128 to a second set of functions, such as unlock vehicle hatch or trunk, start engine, activate horn and/or lights to locate the vehicle, for example. Pressing the second input switch member 130 twice in rapid succession, i.e., typically no more than one or two seconds between activations, could activate an optional third level of functions for the input switch members 124, 126 and 128. These changes in functionality caused by one or more presses of switch member 130 are effective only for a short duration, such as about 2 seconds. The switch members 124, 126, 128, and 130 may have different textures or other tactile cues, such as raised bumps on or near each switch member 124, 126, etc. to enhance the ability of the user to tell by feeling the tactile cues with a finger which switch member 124, 126, etc., is being touched.

The above aspects of the fob which are mounted on the holster 122 of a cell phone, could also be applied in a separate housing which is fixedly or removably attached to the flip, swivel or slide open cover of a cell phone. This still makes the fob completely separate from the cell phone and does not require any interaction of the fob and the cell phone buttons or display. In this case, the fob control circuits are totally separated from the cell phone circuits.

Other fob functions may be integrated with the holster 122, such as alphanumeric, schematic, and pictorial displays, audio feedback, audio communication, and any indication of vehicle status and/or location. The fob control circuits including the battery, signal processor and antenna would be integrated directly in the holster 122 itself. This make the holster 122 effectively a “stand alone” RKE fob which can be used even if the cell phone is not present or in the holster 122.

The second input switch member 130 can also be associated with the emergency position such that a long duration pressing of more than three seconds, for example, will cause the fob 130 to generate control signals which cause the vehicle horn and/or headlights to be activated and/or sound and flash on and off for a long duration of time.

The aspect of the fob 130 shown in FIG. 11A also includes an optional key case 132 integrated with or mounted on the mobile phone holster 122. The key case 132 receives a vehicle ignition key 134 so as to facilitate easy carrying of the mobile phone, vehicle ignition key 134 and a fob 120 in a single device.

In FIG. 11B, the key receptacle 132 is depicted as being integrated on the mobile phone case or holster 122. This integration may be implemented by integral molding of the key case 132 during the formation of the mobile phone holster 122, or by means of a separate attachment using Velcro™, adhesive, a clip, a snap, etc.

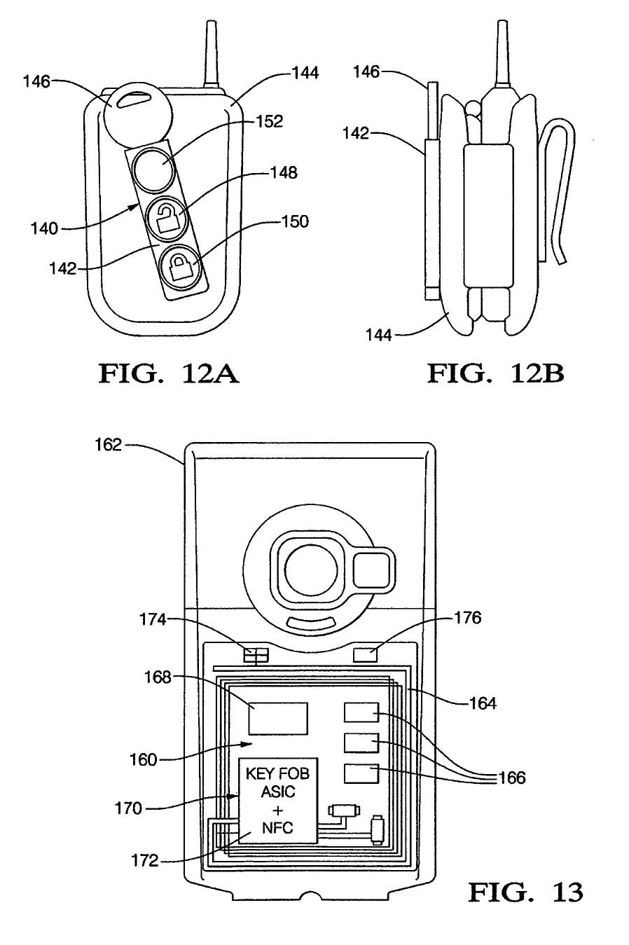

In another aspect shown in FIGS. 12A and 12B, a fob 140 is integrated as part of a key case 142 which may be fixedly or removably attached to another article, such as a mobile phone case 144. A key case 142 similar to the key case 132 described above and shown in FIGS. 11A and 11B provides a receptacle for storage of the vehicle ignition key 146.

The fob 140 includes a first set of two input switch members 148 and 150, respectively associated with vehicle door unlock and vehicle door lock functions. A second input switch member 152 is provided to switch the function of the first input switch member 148 and 150 to a second group of vehicle control functions, such as start engine, briefly activate horn and lights to locate the vehicle, unlock vehicle hatch or trunk, etc.

As shown in FIG. 12B, the key case 142 carrying the integrated fob 140 and providing a receptacle for the vehicle ignition key 146 can be attached to an article worn or carried by a vehicle user, such as a mobile phone case or holster 144 by a suitable means, such as Velcro™ fasteners on opposed surfaces of the holster 144 and the key case 140, or other attachment means, such as magnetic, adhesive, engageable clips, snaps, etc.

In another aspect shown in FIG. 13, a fob 160 is integrated with a mobile device, such as a cellular telephone 162, by means of integration with the exterior surface of the battery cover 164 of the mobile device 162. Alternately, a fob 60 may be integrated with the back surface of a cell phone 162 by mounting the fob components in the housing of the cellular telephone 162 or in a separate member attachable to the back, non-pushbutton, non-display surface of the cellular telephone 162. All of the various fob aspects described above can be integrated with the battery cover 164 including one or more input switch members 166, 168, etc., along with keyless ferrite antennas 170, a display 168, a key fob ASIC 172, etc. Power for the fob 160 is obtained by connecting the fob control circuit to the battery cover contacts 174 and 176 which connect the battery carried in the cover 164 to the mobile device. This provides a significantly greater amount of power to the fob 160 then with a battery mounted in the fob and enables a longer range of communication between the fob 160 and the vehicle RKE.

A UHF antenna may also be provided in the battery cover 164 as part of the fob 160.

The display of the fob 160 can be implemented with E-Ink or OLED technology in order to support the flat shape of the battery cover and to save energy. Foil buttons can be used as the input switch members for a convenient but flat dimension of the input switch member surfaces, which are used for the normal operation of the fob, such as locking and unlocking vehicle doors and the trunk.

All of the fobs 20, 40, etc., described above may have a basic control circuit shown in FIG. 14. A control, such as an ASIC 180, receives inputs from one or more antennas 182 and one or more input switch members all denoted by reference number 184. A transceiver 186, or a separate transmitter and a separate receiver, is connected to the control 180 for transmitting or receiving signals to and from the vehicle RKE 18. A display 188 may be connected to the control 180 by an internal bus system 190.

FIG. 14 depicts electric power being supplied to the fob control

180 and other circuit elements by means of the mobile device battery contacts 174 and 176 shown in FIG. 13. Giving consideration to frequency interference and communication distance limitations, electric power may be supplied to any of the fobs 20, 40, etc., by means of a replaceable battery 192, FIG. 14, which can be removed from the fob housing through a replaceable cover mounted on the fob housing. The battery 192 may also be a rechargeable battery used to power any of the fobs 20, 40, etc. Such a battery 192 requires a recharger 194 coupled to a power source 196 which can be separate from the fob housing so that the battery 192 can be recharged externally of the fob and then reinserted into the fob. Alternately, the rechargeable battery 192 mounted in the fob housing, such as the fob housing 62 shown for the fob 60, may have a solar cell 200 mounted on the exterior thereof forming the power source 196 which generates electricity from sunlight, lamps, etc., to recharge the battery 192 within the fob housing 62. The solar cell 200 could activate the battery recharging circuit any time the ambient light level is sufficiently high. The solar cell 200 can also be a group of series connected solar cells to provide a larger output voltage. A plug 202, shown by way of example in FIG. 3, may also be mounted on the fob housing 52 to provide an electrical connection to an external power source to recharge the battery mounted within the fob housing 52.

Further, power may be supplied from an inductive secondary coil 204 shown by way of example in FIG. 2. The secondary coil 204 is mounted within the fob housing 42 and has current induced therein when another current carrying primary transformer coil, not shown, is placed in close proximity to the fob housing.

In place of a rechargeable battery 192, a chargeable capacitor could also be employed.

The battery 192 may optionally be recharged using other energy scavenging methods. For example, rechargeable power may be mechanical energy derived from mechanical vibrations of the fob housing.

The battery 192 can take the form of a battery in a cellular telephone earbud or headgear. Such batteries are typically rechargeable batteries and need to be periodically recharged. The earbud or cellular telephone headgear power source could be coupled to the fob by mounting the fob on the headgear and directly coupling the headgear power source to the fob.

The fobs 20, 40, etc., may also be provided with optional features. A radio frequency identification device (RFID) 260 shown in FIG. 18, may be integrated with any of the fobs 20, 40, etc., so as to cause the doors of a vehicle to automatically unlock as the person approaches the vehicle (when the vehicle senses the proximity of the RFID device) and automatically lock as the person walks away from the vehicle. The RFID feature could free up or replace one or two input switch button(s) deployed on the fob to enable additional vehicle control functions to be provided on the fob.

An RFID device 260 may also or alternately be used by the vehicle ignition system in conjunction with a vehicle immobilizer function.

In one variation, an RFID device 260 may be used which has no user accessible input switches. In this case, the RFID device 260 locks and unlocks the vehicle doors. The RFID device 260 may also satisfy a vehicle immobilizer circuit, so that the vehicle may be started by the bearer of the device pushing an ignition start button in the vehicle. Other means for inputting data to the RFID device by service personnel may also be employed in order to program the RFID to operate with a specific vehicle.

The RFID device 260 can be directly powered by the vehicle antenna for short range, less than one meter, transmissions. So, the RFID device 260 could be powered from that very short distance using power from the vehicle antenna 17, FIG. 18, coupled in through the fob antenna. In a short range mode, the fob itself, and just the RFID device 260, could be powered that way. This might be useful for some very small, back-up fobs, where the size can be reduced by not having to have a battery. As an emergency back-up fob, the inconvenience of having to be very close to the vehicle for it to work is acceptable. Alternatively, a battery could be used to power it. If the battery is non-rechargeable, then the housing could be designed so that it is replaceable. This might, for example, facilitate making the fob waterproof.

For the aspect in which there is only an RFID device 260 and no user accessible switches, then the circuit shown in FIG. 18 can be used. In this aspect, power from the vehicle RKE antenna 17 is received by the RFID antenna 262 for powering the RFID transceiver 264 and the RFID circuit 266.

For the aspect in which a fob with one or more switches is used, AND there is an RFID device 260, then the circuits of FIGS. 14 and 18 can be merged, so that there is only one battery 192, one recharge circuit 194, and one power source 196.

As described above, in conjunction with the aspect of the fob 50 shown in FIG. 3, either of the output devices, such as LEDs 58 or 59, may be pulsed on a periodic basis to indicate a low fob battery level. Alternately, when the fob 50 senses a low battery level, it can send a signal to the vehicle RKE system 18, which, through the vehicle controller, can result in an alarm message being displayed on the vehicle instrument cluster to indicate a low fob battery.

The second input switch member 130 in FIG. 11A or 140 in FIG. 12A may also be used to control devices external from a vehicle, such as a garage door, house interior and exterior lighting, house alarms, etc. The second input switch member 130 or 152 can be put in a learn mode by a coded sequence of depressions so that when a garage door opener is activated near the fob, the fob learns the correct code to transmit to the garage door to open and close the garage door. Control of the garage door, etc., could also be implemented by input switch members on the other fobs discussed above.

In the aspects of the fob described above which are used with a vehicle key case 132, shown in FIG. 11A or 142 shown in FIG. 12A, a sensor could be employed in the key case 132, 142 or on the article to which the key case 132, 142 is mounted, i.e., the phone holster 122 or 142, to detect whether or not the key 134, 146 is in the case 132, 142 and give an indication when the key 134, 146 is removed from the case 132, 142. This indication may be audible or visible through a light, or by a vibration of the fob housing. The sensor, associated circuitry and sound, vibration or illumination generator could be integrated with either of the vehicle key 134, 146, or the key case 132, 142. The sensor could be, for example, an optical, a capacitive, a conductive, a magnetic, or an RFID tag sensor.

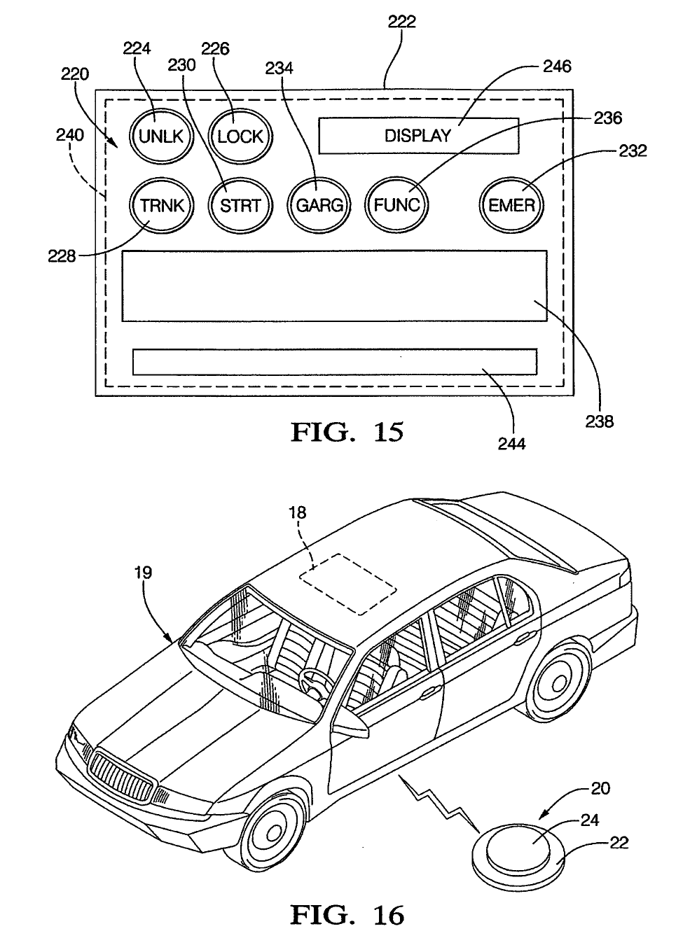

As shown in FIG. 15, a remote keyless entry fob denoted generally by reference number 220 may be integrated into a credit card or debit card 222 or a card having an overall shape of a credit or debit card 222. Various input switch members, such as thin film switches 224, 226, 228, 230, 232, and 234, may be mounted on the card 222 and provided with exterior indicia to designate the associated control function, such as respectively UNLK, LOCK, TRNK, STRT, EMER, and GARG.

An additional input switch member 236 labeled FUNC, by example, may be programmable for user preference or may temporarily assign additional features for a short time to the other input switch members 222, 224, etc., when it is activated.

A passive or active RFID device to unlock or lock the vehicle doors and allow the driver to satisfy the vehicle immobilizer system and to start a vehicle is also mounted in the card 222. As an alternative, the credit or debit card 222 may contain an active or passive RFID device to unlock or lock the vehicle doors and allow the driver to satisfy the vehicle immobilizer system and to start a vehicle without the other functionality of the card 222. That is the card 222 would not have manual inputs to control the vehicle or a display.

For the RFID functions, the driver may need to put his or her hand on or near a vehicle door handle so that the driver intent may be sent. Once inside the vehicle, the driver needs to press a vehicle start button. An antenna 240 shown in dashed lines on the card 222 is provided for transmitting pulse signals from the fob 220 to the vehicle RKE system. Other antennas may also be provided within the card 222 for different communication ranges, etc.

For use as a credit or debit card, the card 222 may be thinner at the bottom portion containing a magnetic stripe 244 to enable the card 222 to be easily passed through existing credit card magnetic stripe readers.

The card 222 supplied which may include a battery and/or solar cells 238. The onboard battery may be powered by the solar cells 238, or recharged by the solar cells 238 or an inductive coil as described above and shown on FIG. 3 or FIG. 2 as a secondary coil of a transformer.

A display 246 may also be provided on the card 222 for displaying various information, such as the last key fob function used, whether the last signal sent by the fob 222 to the vehicle was received by the vehicle (bidirectional communication where a receiver or transceiver is required) a battery-charge state, etc.

What is claimed is:

1. A vehicle control apparatus adapted to control at least one vehicle control function, the apparatus comprising:
a remote access receiver adapted to be carried on the vehicle and generating signals to operate the vehicle control functions;
a remote communication apparatus including:
a housing;
an input switch on the housing for selecting at least one vehicle control functions;
a control carried in the housing, the control generating a signal associated with a vehicle control function selected by the input;
a transmitter carried in the housing and connected to the control for transmitting a signal to the remote access apparatus on the vehicle; and
an attachment, the attachment mounting the housing on a separate article which is one of carried by and worn by the user.

2. The apparatus of claim 1 wherein the attachment is one of a clip, a snap, a band with joinable ends, an adhesive, a pin, a tack, and a magnetic connector the article.

3. The apparatus of claim 1 wherein the attachment functions to one of an integrating the housing with the article and attaching the housing to the article.

4. The apparatus of claim 1 further comprising:
the attachment enabling at least partial concealment of the housing on the article.

5. The apparatus of claim 1 wherein the input switch comprises:
a multifunction switch for selecting at least two vehicle control functions.

6. The apparatus of claim 1 further comprising:
a battery power source carried in the housing and providing power to the control and the transmitter.

7. The apparatus of claim 6 wherein the battery power source is a rechargeable battery.

8. The apparatus of claim 7 wherein the rechargeable battery includes one of a connection to a plug for supplying recharging power to the battery externally of the housing, a secondary transformer inductive coil carried in the housing for supplying current to the battery in response to a proximate association with an external current carrying transformer primary coil, and a solar cell carried on the housing and connected to the battery for supplying solar recharging power to the battery.

9. The apparatus of claim 6 further comprising:
a battery power level detector carried in the housing and generating the signal indicative of a low battery power level; and
an indicator carried on the housing and indicating low battery power level.

10. The apparatus of claim 1 wherein the attachment mounts the housing on at least one of a purse, a handbag, a briefcase, a watchband, a belt, a badge worn by a user, a piece of jewelry worn by a user, an article of clothing, a pen, a pencil, and a key case.

11. The apparatus of claim 1 wherein the attachment mounts the housing on at least one of a cellular telephone holder, a cellular telephone case, a cellular telephone holster, a cellular telephone battery cover, a cellular telephone bud, and cellular telephone head gear.

12. The apparatus of claim 1 wherein the attachment mounts the housing on at least one of a cellular telephone ear bud and, cell phone head gear.

13. The apparatus of claim 1 wherein attachment integrates the housing with a vehicle key.

14. The apparatus of claim 13 wherein the housing is at least 20% shorter than an exposed length of the key.

15. The apparatus of claim 13 wherein the housing is at least 30% shorter than an exposed length of the key.

16. The apparatus of claim 1 further comprising:
an optical function indicator, carried on the housing, for indicating a vehicle function selected by the input.

17. The apparatus of claim 1 further comprising:
a visible indicator, carried on the housing, for indicating that a selected vehicle control function transmitted by the transmitter to the vehicle remote access receiver has been received by the vehicle remote access receiver.

18. The apparatus of claim 1 further comprising:
an RFID circuit carried by the housing and generating an RFID signal.

19. The apparatus of claim 18 wherein:
the RFID signal adapted for use to at least one of unlock the driver's door, unlock all the doors, lock all doors, and start the vehicle.

20. The apparatus of claim 1 wherein the input switch comprises:
at least one of a pressible member, a slidable multi-position member, and a rotary multi-position member.

21. The apparatus of claim 19 wherein:
the slidable member and the rotary member each have multiple positions, each position associated with a distinct vehicle control function; and
a selector switch, carried on the housing, for inputting a signal from the input switch member corresponding to the position of and the control function associated with the input switch member to the control.

22. The apparatus of claim 20 further comprising:
a second input switch carried on the housing, the second input switch coupled to the control and generating a signal to the control, in response to which, the control changes the vehicle control function associated with a first input switch member.

23. The apparatus of claim 1 wherein:
the control is responsive to at least one of the number of closely time spaced sequential activations of the input switch and the duration of each activation to select one of at least two of the vehicle control functions.

24. The apparatus of claim 1 wherein:
the housing is a separable battery cover of a cellular telephone, the attachment mounting the input switch, the control, and the transmitter on the battery cover.

25. The apparatus of claim 24 further comprising:
connections carried by the battery cover and coupled to the control, for supplying electric power from a cellular telephone battery carried in the battery cover to the control.

26. The apparatus of claim 1 wherein:
the housing is a thin card; and
the input switch, the control, and the transmitter are mounted on the card.

27. The apparatus of claim 26 wherein:
the card is one of a credit card and a debit card.

28. The apparatus of claim 1 further comprising:
the fob including means responsive to a signal received from the vehicle concerning vehicle status, for giving an indication to the user of at least one of the presence of a vehicle system alert and the nature of the vehicle system alert using at least one of an optical indicator on the housing of the fob, a vibration of the housing, and an audible beep.

29. A vehicle control apparatus adapted to control at least two vehicle control functions, the apparatus comprising:
a remote access receiver adapted to be carried on the vehicle and generating signals to operate the vehicle control functions;
a remote communication apparatus including:
a housing;
a multifunctional input switch on the housing for selecting at least one of two vehicle control functions;
a control carried in the housing, the control generating a signal associated with a vehicle control function selected by the input; and
a transmitter carried in the housing and connected to the control for transmitting a signal to the remote access apparatus on the vehicle.

30. The apparatus of claim 29 further comprising:
an attachment enabling a user to attach the housing to one of an article that is worn and carried by the user.

31. The apparatus of claim 30 wherein the attachment comprises:
at least one of a tab, Velcro™, and an adhesive.

32. The apparatus of claim 30 wherein the attachment comprises:
at least one of a clip, a snap, a band with joinable ends, and a magnetic connector.

33. The apparatus of claim 30 further comprising:
the attachment enabling at least partial concealment of the housing on the article.

34. The apparatus of claim 29 further comprising:
an optical function indicator, carried on the housing, for indicating a vehicle function selected by the input.

35. The apparatus of claim 29 wherein the multifunctional input switch comprises:
at least one of a pressible member, a slidable multi-position member, and a rotary multi-position member.

36. The apparatus of claim 35 wherein:
the slidable member and the rotary member each have multiple positions, each position associated with a distinct vehicle control function; and
a selector switch, carried on the housing, for inputting a signal from the input switch member corresponding to the position of and the control function associated with the input switch member to the control.

37. The apparatus of claim 29 further comprising:
a second input switch carried on the housing, the second input switch coupled to the control and generating a signal to the control, in response to which, the control changes the vehicle control function associated with a first input switch member.

38. The apparatus of claim 29 wherein:
the control is responsive to at least one of the number of time spaced sequential activations of the input switch and the duration of each activation to select one of at least two of the vehicle control functions.

39. The apparatus of claim 29 wherein the attachment mounts the housing on at least one of a purse, a handbag, a briefcase, a watchband, a belt, a badge worn by a user, a piece of jewelry worn by a user, an article of clothing, a cellular phone holder, a cellular telephone case, a cellular telephone holster, a key case, a cellular telephone ear bud, and cellular telephone head gear.

40. The apparatus of claim 29 wherein the housing is integrated with a vehicle key and the housing is at least about 20% to about 30% shorter than an exposed length of the key.

41. The apparatus of claim 29 further comprising:
the fob including means, responsive to a signal received from the vehicle concerning vehicle status, for giving at indication to the user of at least one of the presence of a vehicle system alert and the nature of the vehicle system alert using at least one of an optical indicator on the housing of the fob, a vibration of the housing, and an audible beep.

42. The apparatus of claim 30 wherein:
the attachment functions to one of an integrating the housing with the article and attaching the housing to the article.

43. A vehicle control apparatus adapted to control at least one vehicle control function, the apparatus comprising:
a remote access receiver adapted to be carried on the vehicle and generating signals to operate the vehicle control functions;
a remote communication apparatus including:
a housing;
only one input switch on the housing for selecting at least one vehicle control function,
a control carried in the housing, the control generating a signal associated with a vehicle control function selected by the input;
a transmitter carried in the housing and connected to the control for transmitting a signal to the remote access apparatus on the vehicle; and
an attachment, the attachment mounting the housing on a separate article which is one of carried by and worn by the user.

44. The apparatus of claim 43 wherein:
the one input switch is one of a single pressible input switch, a slider switch, and a rotary switch which is adapted to at least one of unlock one vehicle door, unlock at least two vehicle doors, lock the vehicle doors, and activate the vehicle horn and lights, depending upon the number and duration of time spaced activations of the one input switch.

45. The apparatus of claim 43 wherein:
the one input switch is one of a single pressible input switch, a slider switch, and a rotary switch which is adapted to only unlock one of a single vehicle door and multiple vehicle doors.

46. The apparatus of claim 43 wherein:
the one input switch is activated by one of a flexure of the housing and a squeezing of the housing.

47. The apparatus of claim 43 wherein the attachment comprises:
at least one of a tab, Velcro™, an adhesive, a clip, a snap, a band with joinable ends, and a magnetic connector.

48. The apparatus of claim 43 further comprising:
the attachment enabling at least partial concealment of the housing on the article.

49. The apparatus of claim 43 wherein:
the attachment functions to one of an integrating the housing with the article and attaching the housing to the article.

50. The apparatus of claim 43 wherein the attachment mounts the housing on at least one of a purse, a handbag, a briefcase, a watchband, a belt, a ring, a badge worn by a user, a piece of jewelry worn by a user, an article of clothing, a cellular phone holder, a cellular telephone case, a cellular telephone holster, a pen, a pencil, and a key case.

51. The apparatus of claim 43 wherein the housing is integrated with a vehicle key and the housing is at least 20% shorter than an exposed length of the key.

52. The apparatus of claim 43 wherein the housing is integrated with a vehicle key and the housing is at least 30% shorter than an exposed length of the key.

53. The apparatus of claim 43 wherein:
the control is responsive to at least one of the number of time spaced sequential activations of the one input switch and the duration of each activation to select at least one of the vehicle control functions.

54. The apparatus of claim 43 further comprising:
an RFID circuit carried by the housing and generating an RFID signal.

55. The apparatus of claim 54 wherein:
the RFID signal adapted to at least one of unlock the driver's door, unlock all the doors, lock all doors, and start the vehicle.

56. The apparatus of claim 43 further comprising:
a battery power source carried in the housing and providing power to the control and the transmitter, wherein the battery power source is one of a non-rechargeable battery and a rechargeable battery.

57. The apparatus of claim 56 wherein the rechargeable battery includes one of a connection to a plug for supplying recharging power to the battery externally of the housing, a secondary transformer inductive coil carried in the housing for supplying current to the battery in response to a proximate association with an external current carrying transformer primary coil, and a solar cell carried on the housing and connected to the battery for supplying solar recharging power to the battery.

58. The apparatus of claim 43 wherein the attachment mounts the housing on at least one of the housing of a cellular telephone ear bud and a cellular telephone headgear.

59. The apparatus of claim 58 comprising:
means, coupled to one of the ear bud and the headgear, for supplying electrical power to the control and the transmitter.

60. A vehicle control apparatus adapted to control at least one vehicle control function, the apparatus comprising:
a remote access transceiver adapted to be carried on the vehicle and generating signals to operate the vehicle control functions;
a remote communication apparatus including:
a housing;
an RFID circuit carried by the housing and generating an RFID signal used to control the vehicle functions, wherein the RFID circuit communicates with the transceiver for transmitting the signal to the remote access transceiver on the vehicle; and
an attachment, the attachment adapted for mounting the housing on a separate article which is one of carried by and worn by the user.

61. The apparatus of claim 60 wherein:
the RFID is adapted to at least one of unlock the driver's door, unlock all the doors, and lock all doors.

62. The apparatus of claim 61 wherein:
the RFID signal is adapted to start the vehicle.

63. The apparatus of claim 60 wherein
the attachment mounts the housing on at least one of a purse, a handbag, a briefcase, a cellular telephone holder, a cellular telephone case, a cellular telephone holster, a watchband, a belt, a badge worn by a user, a piece of jewelry worn by a user, an article of clothing, a pen, a pencil, and a key case.

64. The apparatus of claim 60 wherein:
the attachment mounts the housing a thin card.

65. The apparatus of claim 64 wherein:
the card is one of a card having an overall shape of a credit card, a credit card and a debit card.

66. The apparatus of claim 60 wherein
the attachment mounts the housing on at least one of a cellular telephone battery cover, a cellular telephone housing, a cellular telephone battery, a cellular telephone interior part, a cellular phone ear bud, and cellular phone head gear.

67. The apparatus of claim 60 further comprising:
a battery power source carried in the housing and providing power to the RFID circuit and the transmitter.

68. The apparatus of claim 65 wherein the battery power source is a rechargeable battery.

69. The apparatus of claim 67 wherein the rechargeable battery includes one of a connection to a plug for supplying recharging power to the battery externally of the housing, a secondary transformer inductive coil carried in the housing for supplying current to the battery in response to a proximate association with an external current carrying transformer primary coil, and a solar cell carried on the housing and connected to the battery for supplying solar recharging power to the battery.

70. The apparatus of claim 60 further comprising:
an electrical power source adapted to be carried on the article to which the housing is attached; and
electrical connections between the RFID and the power source.

71. The apparatus of claim 60 wherein the RFID circuit receives electric power from an antenna on the vehicle, when the housing is in proximity with the vehicle.

72. The apparatus of claim 60 further comprising:
the attachment enabling at least partial concealment of the housing on the article.

73. The apparatus of claim 60 wherein the attachment comprises:
an adhesive backing on the housing;
a removable cover on the backing, the cover being removable from the backing to enable the housing to be attached to a separate article.

74. The apparatus of claim 60 wherein:
the attachment functions to one of an integrating the housing with the article and attaching the housing to the article.
